(19) United States
(12) Patent Application Publication
(10) Pub. No.: US 2024/0358052 A1
(43) Pub. Date: Oct. 31, 2024

(54) SWEETENER COMPOSITIONS AND METHODS OF PRODUCTION THEREOF

(71) Applicant: OPTIBIOTIX LIMITED, York (GB)

(72) Inventors: Stephen O'Hara, York (GB); Sofia Kolida, York (GB)

(21) Appl. No.: 18/688,591

(22) PCT Filed: Sep. 2, 2022
(86) PCT No.: PCT/GB2022/052252

§ 371 Date: Mar. 1, 2024

(30) Foreign Application Priority Data
Sep. 3, 2021 (GB) 2112610.7

(51) Int. Cl. A23L 27/30

(52) U.S. Cl. CPC A23L 27/36

(57) ABSTRACT

The present invention relates to a composition comprising a levansucrase modified high intensity sweetener glycoside, a polysaccharide and an unmodified high intensity sweetener glycoside. The invention also relates to a method for enzymatically modifying a high intensity sweetener glycoside comprising contacting the high intensity sweetener glycoside with a levansucrase in the presence of a monosaccharide acceptor to produce an enzymatically modified high intensity sweetener glycoside and a polysaccharide. The invention also relates to the use of the composition as a low calorie sweet functional fibre, sweet prebiotic or as a bulk sugar replacement. The invention also relates to the use of a levansucrase for fructosylating a high intensity sweetener glycoside.

### CROSS-REFERENCE TO RELATED APPLICATIONS

This application is a U.S. National Stage of International Application No. PCT/GB2022/052252, filed Sep. 2, 2022, which claims priority to GB 2112610.7 filed on Sep. 3, 2021, the entire contents of which are incorporated herein by reference.

### TECHNICAL FIELD OF THE INVENTION

The invention relates to a composition comprising a levansucrase modified high intensity sweetener glycoside, a polysaccharide and an unmodified high intensity sweetener glycoside. The composition has use as a sweetener as a functional fibre. The invention also relates to a method for enzymatically modifying a high intensity sweetener glycoside resulting in the simultaneous production of an enzymatically modified high intensity sweetener glycoside, a polysaccharide and an unmodified high intensity sweetener glycoside.

### BACKGROUND TO THE INVENTION

The global sweetener market is currently dominated by sugar and is forecast to reach $112 bn by 2022. There is an increasing move towards low calorie or calorie free sweeteners due to a number of health concerns associated with the excessive consumption of sucrose. A number of sweeteners, such as mogroside V and steviol glycosides are classified as high intensity sweeteners (HIS) and have reported sweet potencies relative to sucrose of approximately 150×, 250× and 400× respectively. However, a number of HIS are associated with bitter or other “off” notes (such as liquorice flavours) which reduce their appeal to consumers.

Prebiotics are functional fibre substrates that are selectively utilized by gut microorganisms, such as lactobacilli or bifidobacteria, conferring a health benefit to the host, and are finding much increased application into the food sector. Prebiotics can be non-digestible food ingredients that are selectively metabolised by colonic bacteria which contribute to improved health. As such, their use can promote beneficial changes within the indigenous gut microbiota and their activity and they could help survivability of probiotics. They are distinct from most dietary fibres like pectin, celluloses, xylan, which have a global effect on gut bacterial populations and are not selectively metabolised in the gut.

Commercial enzymes used in the modification of high intensity sweeteners result in the fructosylation of steviol glycosides and mogrosides, but transfructosylation is not their main enzymatic activity and so they also deglycosylate their substrates. This results in deglycosylated compounds which can have an unpleasant, bitter taste.

It is an object of the present invention to provide a composition which can impart a sweet taste and prebiotic functionality, with low bitter and/or an undesirable after tastes. It is also an object of the present invention to provide enzymes and a process in which the enzymes fructosylate sweeteners but with no or substantially less deglycosylation than existing inventions.

### SUMMARY OF THE INVENTION

In accordance with a first aspect of the present invention, there is provided a composition comprising:

a. a levansucrase modified high intensity sweetener glycoside;

b. a polysaccharide; and

c. unmodified high intensity sweetener glycoside.

Advantageously the composition provides sweetness through the levansucrase modified high intensity sweetener glycoside and the unmodified high intensity sweetener glycoside. In addition, the composition provides prebiotic fibre functionality through the polysaccharide. By “unmodified high intensity sweetener glycoside” it is meant a high intensity sweetener glycoside that has not been modified, including enzymatically modified.

The levansucrase modified high intensity sweetener glycoside and unmodified high intensity sweetener glycoside may be the same high intensity sweetener glycoside. Preferably, the high intensity sweetener glycoside which is levansucrase modified or remains unmodified is a mogroside or a derivative thereof. The mogroside may be mogroside V.

The polysaccharide may be levan.

The enzymatically modified high intensity sweetener glycoside may be a fructosylated high intensity sweetener. The levansucrase may be derived from a microorganism. Preferably the levansucrase is derived from a Bacillus species.

Preferably, the fructosylated high intensity sweetener glycoside comprises more than one additional fructose molecule. The fructosylated high intensity sweetener glycoside may comprise up to 7 additional fructose molecules.

Preferably the fructosylated high intensity sweetener glycoside has a lower sweetness value than the unmodified high intensity sweetener glycoside. Preferably the fructosylated high intensity sweetener glycoside has a higher sweetness value than levan.

Preferably the fructosylated high intensity sweetener glycoside is a fructosylated diterpene or triterpene glycoside. Suitably the fructosylated diterpene or triterpene glycoside has the formula [(glu)ₓ-L-(glu)_{y}](fru)_{z}; wherein L is the diterpene or triterpene moiety, x and y are each independently integers from 1 to 3 and z is an integer from 1 to 8 or 1 to 7. The fructosylated high intensity sweetener glycoside may be a mixture of compounds having different values of z and/or different isomers of compounds having particular values of z. Such isomers may have the fructose moiety bonded to different positions on the L moiety and/or may be different isomers of oligo fructose.

Suitably L is a cucurbitane or steviol moiety, suitably cucurbitane or steviol. Suitably the fructose moieties are bonded through glycosidic bonds with one or more of the glucose moieties. Suitably the fructose moiety (fru)_{z} is provided by a fructose molecule or an oligo fructose molecule bonded to a one of the glucose moieties (glu) through a glycosidic bond.

In embodiments wherein L is cucurbitane, the fructosylated high intensity sweetener glycoside is a fructosylated mogroside and has the formula (I):

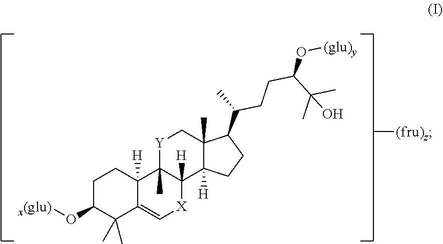

wherein X is C═O or CH₂ and Y is C═O or CHOH (suitably with R stereochemistry). In some embodiments, X is C═O and Y is CHOH (suitably with R stereochemistry). In some embodiments, X is CH₂ and Y is C═O.

Suitably the fructosylated mogroside has the formula (Ia), (Ib), (Ic) or (Id):

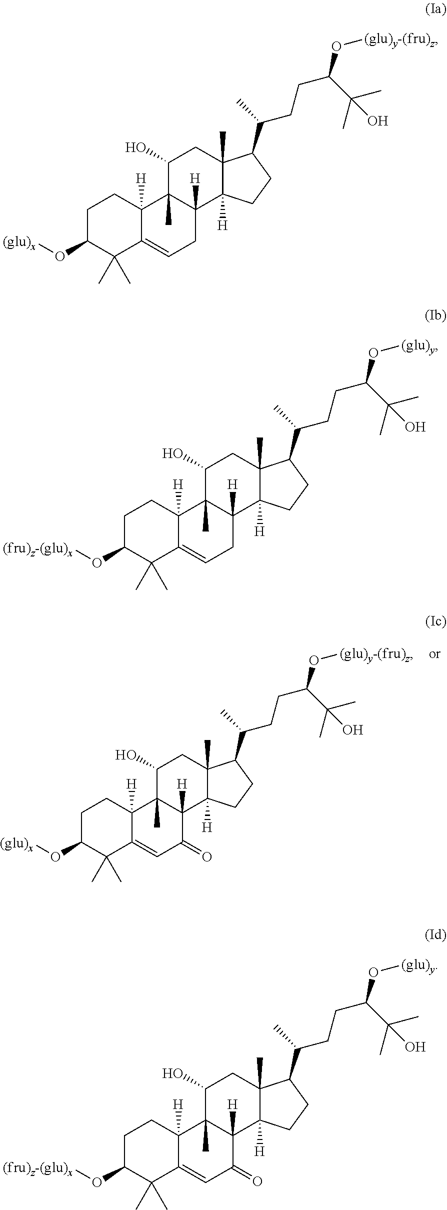

The mogroside which is fructosylated may be selected from mogroside I, mogroside II, mogroside IIe, mogroside III, mogroside IIIe, mogroside IV, mogroside V, isomogroside V, 7-oxo mogroside or siamenoside I, suitably wherein the fructose moieties are bonded through glycosidic bonds with one or more of the glucose moieties. In such embodiments the glucose moieties (glu)ₓ and (glu)_{y} have the x and y values and structure of the respective mogroside compounds. Preferably the fructosylated mogroside is fructosylated mogroside IV, fructosylated mogroside V, fructosylated 7-oxo mogroside or fructosylated siamenoside I. Preferably the fructosylated mogroside is fructosylated mogroside V or fructosylated 7-oxo mogroside. The fructosylated mogroside V may have the formula (IIa) or (IIb):

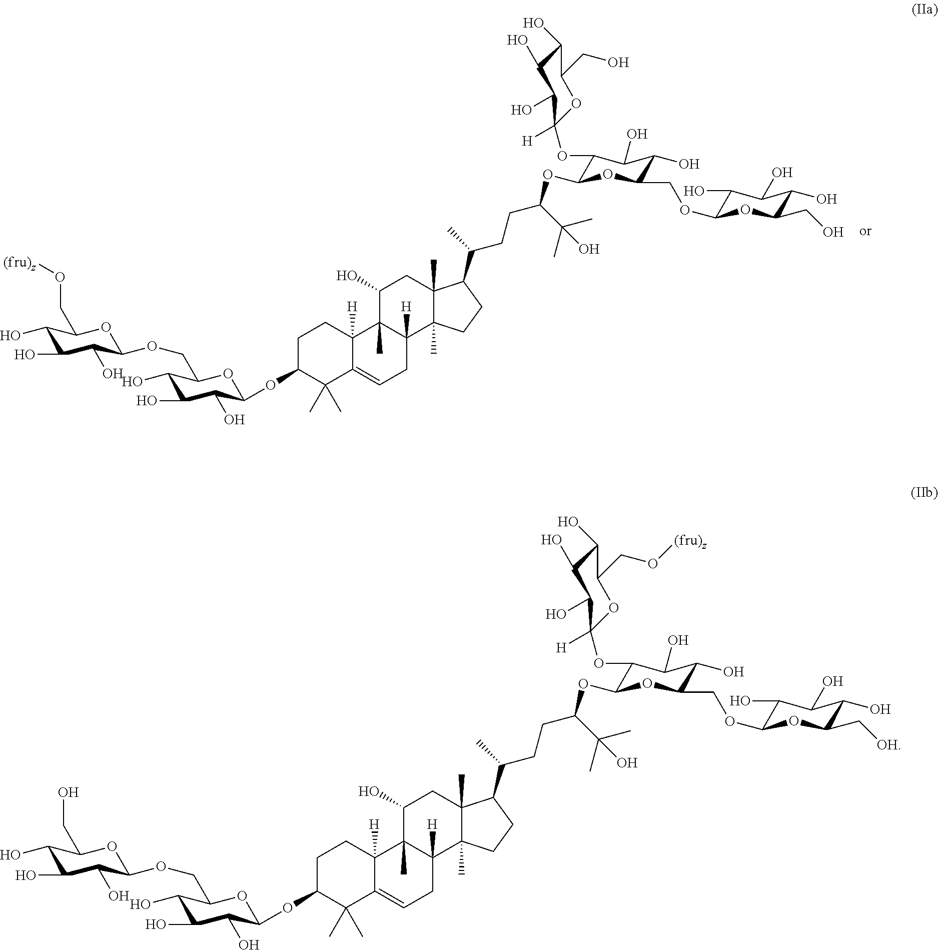

The fructosylated 7-oxo mogroside may have the formula (IIIa) or (IIIb):

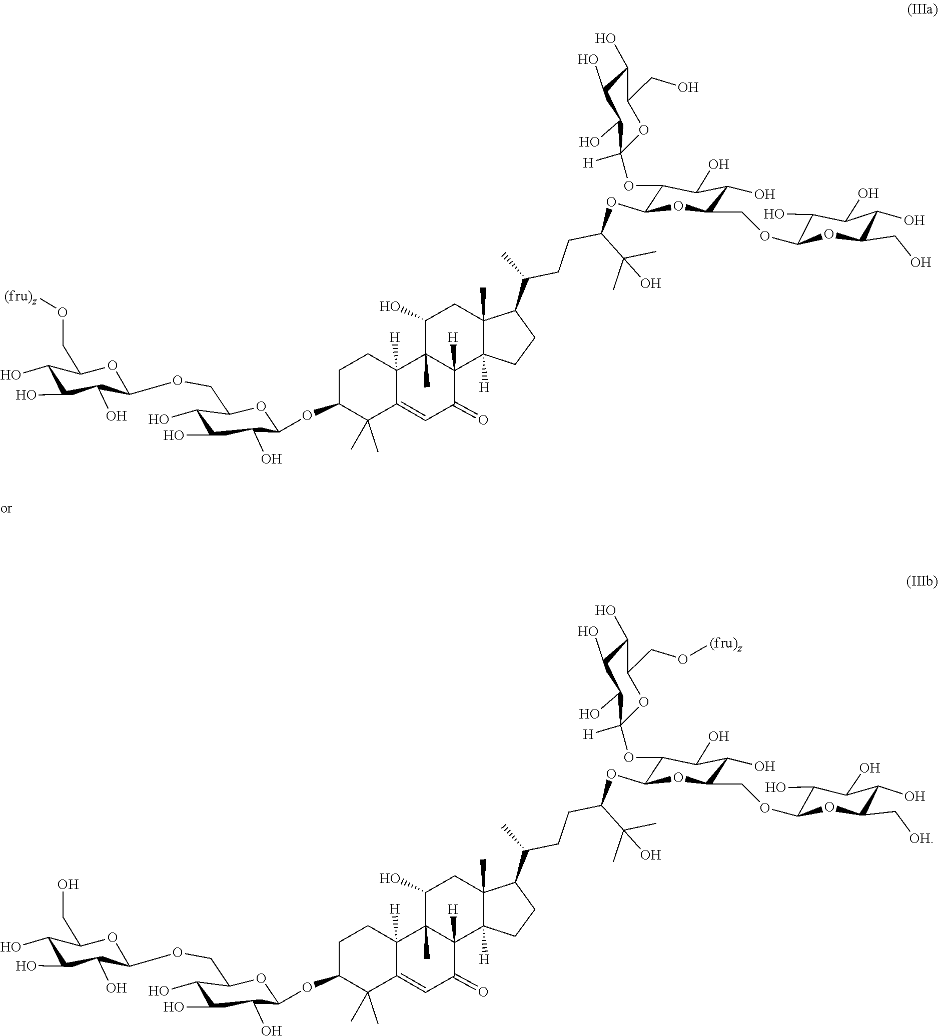

Preferably the composition has a reduced bitter flavour when compared to a composition not comprising a levansucrase modified high intensity sweetener glycoside. Preferably the composition has a reduced liquorice flavour when compared to a composition not comprising an enzymatically modified high intensity sweetener glycoside. Preferably the composition has an improved flavour when compared to a composition not comprising an levansucrase modified high intensity sweetener glycoside.

Preferably the composition has a reduced bitter flavour when compared to a composition comprising an enzymatically modified high intensity sweetener glycoside produced by commercial enzymes. Preferably the composition has a reduced liquorice flavour when compared to a composition comprising an enzymatically modified high intensity sweetener glycoside produced by commercial enzymes. Preferably the composition has an improved flavour when compared to a composition comprising an levansucrase modified high intensity sweetener glycoside produced by commercial enzymes.

The composition may be for incorporation in, or on, a food stuff, a food supplement or a calorie restricted meal replacement product. The composition may also be used to replace part, the majority, or all, of the bulk sugar content in a foodstuff or used by itself as a sweetener. Advantageously, the inventors of the present invention have found that the composition has a clean flavour profile, a low glycaemic index, which may be classified as fibres and help to maintain gut microbiome diversity and enhancement of health positive bacteria. The composition may be in a granular, powdered, or liquid form.

The composition may be incorporated into a food product, by way of blending or mixing the composition with other ingredients. Alternatively, the composition may be used to coat a food product.

The term “foodstuff” is intended to mean any material which can be safely ingested by a human or animal, including, but not limited to foods, beverages, cereals, bakery products, breaded and battered products, dairy products, confectionary, snacks, and meals. The term includes those products which require reconstitution prior to being cooked or eaten. The term also includes any food supplements or medicaments (such as vitamin tablets or antibiotic liquids).

In accordance with a second aspect of the present invention, there is provided a method for enzymatically modifying a high intensity sweetener glycoside comprising:

contacting the high intensity sweetener glycoside with a levansucrase in the presence of a monosaccharide acceptor to produce an enzymatically modified high intensity sweetener glycoside and a polysaccharide.

Preferably, the high intensity sweetener glycoside is a mogroside or a derivative thereof, as described in relation to the first aspect. The mogroside may be mogroside V.

The concentration of mogroside V may be in the range of about 0.01% to about 100 wt %, and preferably in the range of about 0.2% to about 15 wt %.

The levansucrase may be derived from a microroganism. Preferably the levansucrase is derived from a Bacillus species. Advantageously levansucrase derived from a Bacillus species can synthesise fructosylated mogroside V. The activity of the levansucrase may be in the range of about 0.10 to about 1 U/ml, and preferably in the range of about 0.05 to about 0.5 U/ml.

Preferably the polysaccharide is levan.

Preferably the levansucrase modified high intensity sweetener glycoside is a fructosylated high intensity sweetener glycoside, as described in relation to the first aspect. The fructosylated high intensity sweetener glycoside may comprise at least one additional fructose molecule. The fructosylated high intensity sweetener glycoside may comprise more than one additional fructose molecule. The fructosylated high intensity sweetener glycoside may comprise up to 7 additional fructose molecules.

Advantageously the method results in no deglycosylation of the high intensity sweetener which results in a reduction of bitter flavours compared to an enzymatically modified high intensity sweetener modified using other enzymes.

Preferably the monosaccharide donor is sucrose. Sucrose may be present at an initial concentration of in the range of about 50 to about 600 g/L.

In accordance with another aspect of the present invention, there is provided a fructosylated high intensity sweetener glycoside which has been enzymatically modified using a levansucrase.

Preferably, the high intensity sweetener glycoside is a mogroside or a derivative thereof. The mogroside may be mogroside V.

Preferably the levansucrase is derived from a Bacillus species.

Preferably, the fructosylated high intensity sweetener glycoside enzymatically modified using a fructosyltransferase comprises more than one additional fructose molecule. The fructosylated high intensity sweetener glycoside may comprise up to 8 or up to 7 additional fructose molecules.

Preferably the fructosylated high intensity sweetener glycoside enzymatically modified using a fructosyltransferase has a reduced bitter and liquorice flavour when compared to a non-fructosylated high intensity sweetener glycoside. The fructosylated high intensity sweetener glycoside enzymatically modified using a fructosyltransferase may have a significantly lower sweetness than a non-fructosylated high intensity sweetener glycoside. Preferably the fructosylated high intensity sweetener has an improved flavour when compared to a non-fructosylated high intensity sweetener glycoside.

Preferably the fructosylated high intensity sweetener has an improved flavour when compared to a fructosylated high intensity sweetener glycoside produced by commercial enzymes. Preferably the fructosylated high intensity sweetener has a sweetness comparable to sucrose.

The fructosylated high intensity sweetener may be for incorporation in, or on, a food stuff, a food supplement or a calorie restricted meal replacement product. The fructosylated high intensity sweetener may also be used to replace part, the majority, or all, of the bulk sugar content in a foodstuff or used by itself as a sweetener. Advantageously, the inventors of the present invention have found that the fructosylated high intensity sweeteners have a clean flavour profile, a low glycaemic index, which may be classified as fibres and help to maintain gut microbiome diversity and enhancement of health positive bacteria. The fructosylated high intensity sweetener may be in a granular or powdered form.

It will be apparent to the skilled addressee that the fructosylated high intensity sweetener glycosides may be incorporated into a product, by way of blending or mixing the glycosides with other ingredients. Alternatively, the fructosylated high intensity sweetener glycosides may be used to coat a product.

In accordance with another aspect of the present invention, there is provided the use of a levanscurase for fructosylating a high intensity sweetener glycoside.

Preferably, the high intensity sweetener glycoside is a mogroside or a derivative thereof. The mogroside may be mogroside V.

The levansucrase may be derived from a bacterium. Preferably the levansucrase is derived from a Bacillus species.

According to a further aspect of the present invention, there is provided a fructosylated high intensity sweetener glycoside. Suitably the fructosylated high intensity sweetener glycoside is produced by the method of second aspect.

Suitably the fructosylated high intensity sweetener glycoside is a fructosylated diterpene or triterpene glycoside. Suitably the fructosylated diterpene or triterpene glycoside has the formula [(glu)ₓ-L-(glu)_{y}] (fru)_{z}; wherein L is the diterpene or triterpene moiety, x and y are each independently integers from 1 to 3 and z is an integer from 1 to 8 or 1 to 7. The fructosylated high intensity sweetener glycoside may be a mixture of compounds having different values of z and/or different isomers of compounds having particular values of z. Such isomers may have the fructose moiety bonded to different positions on the L moiety and/or may be different isomers of oligo fructose.

Suitably L is a cucurbitane or steviol moiety, suitably cucurbitane or steviol. Suitably the fructose moieties are bonded through glycosidic bonds with one or more of the glucose moieties. Suitably the fructose moiety (fru)_{z} is provided by a fructose molecule or an oligo fructose molecule bonded to a one of the glucose moieties (glu) through a glycosidic bond.

In embodiments wherein L is cucurbitane, the fructosylated high intensity sweetener glycoside is a fructosylated mogroside and has the formula (I):

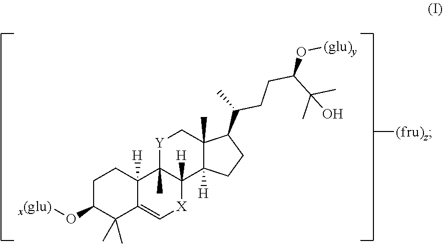

wherein X is C═O or CH₂ and Y is C═O or CHOH (suitably with R stereochemistry). In some embodiments, X is C═O and Y is CHOH (suitably with R stereochemistry). In some embodiments, X is CH₂ and Y is C═O.

Suitably the fructosylated mogroside has the formula (Ia), (Ib), (Ic) or (Id):

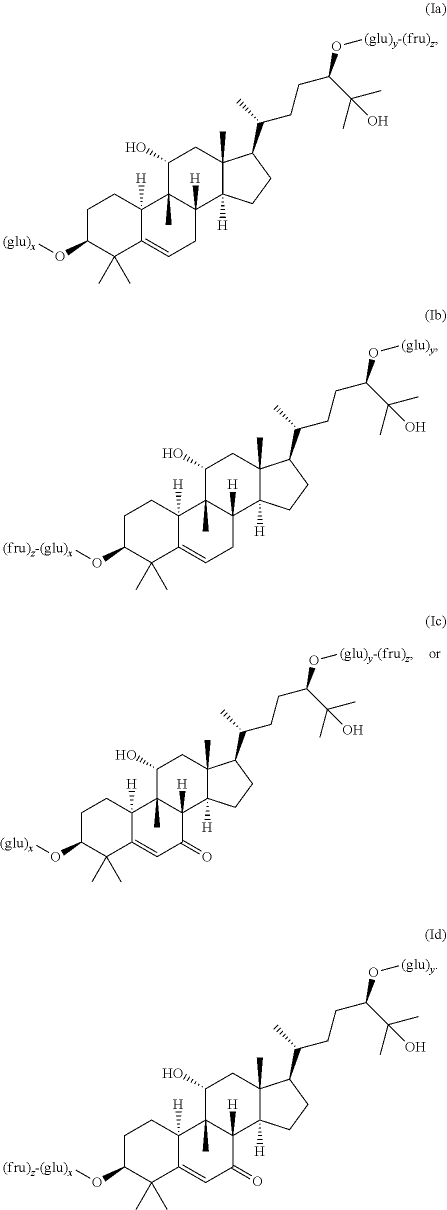

The mogroside which is fructosylated may be selected from mogroside I, mogroside II, mogroside IIe, mogroside III, mogroside IIIe, mogroside IV, mogroside V, isomogroside V, 7-oxo mogroside or siamenoside I, suitably wherein the fructose moieties are bonded through glycosidic bonds with one or more of the glucose moieties. In such embodiments the glucose moieties (glu)ₓ and (glu)_{y} have the x and y values and structure of the respective mogroside compounds. Preferably the fructosylated mogroside is fructosylated mogroside IV, fructosylated mogroside V, fructosylated 7-oxo mogroside or fructosylated siamenoside I. Preferably the fructosylated mogroside is fructosylated mogroside V or fructosylated 7-oxo mogroside. The fructosylated mogroside V may have the formula (IIa) or (IIb):

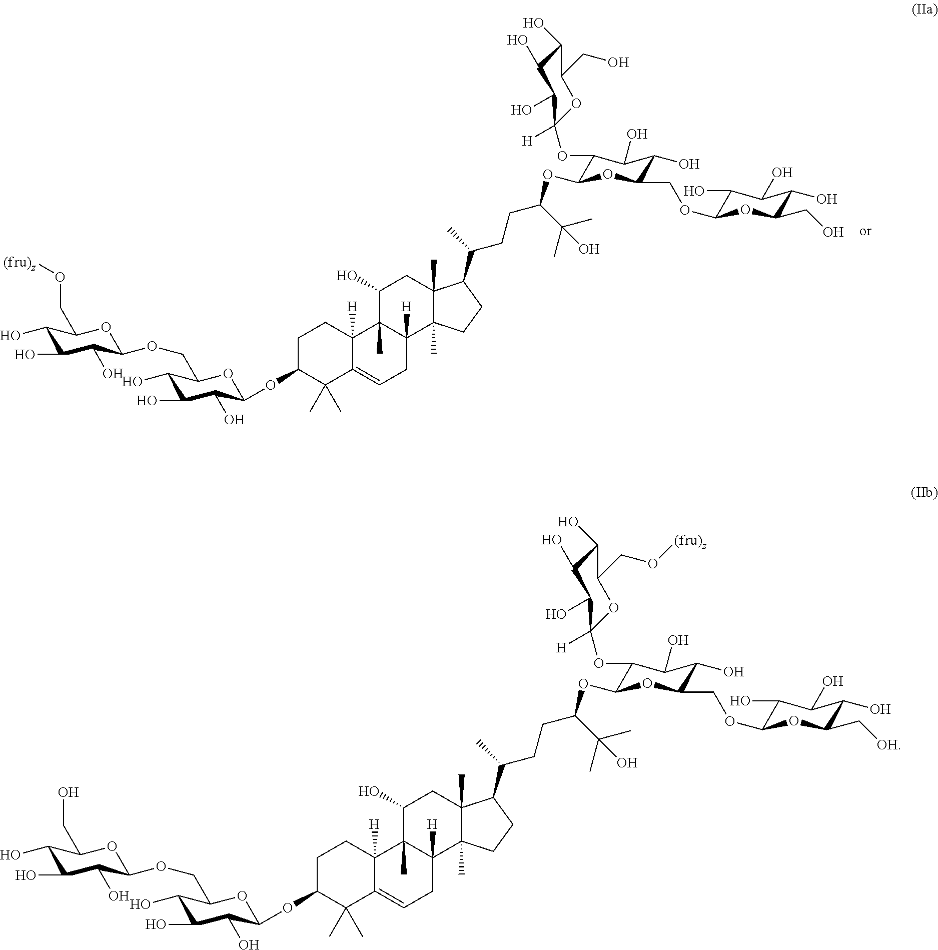

The fructosylated 7-oxo mogroside may have the formula (IIIa) or (IIIb):

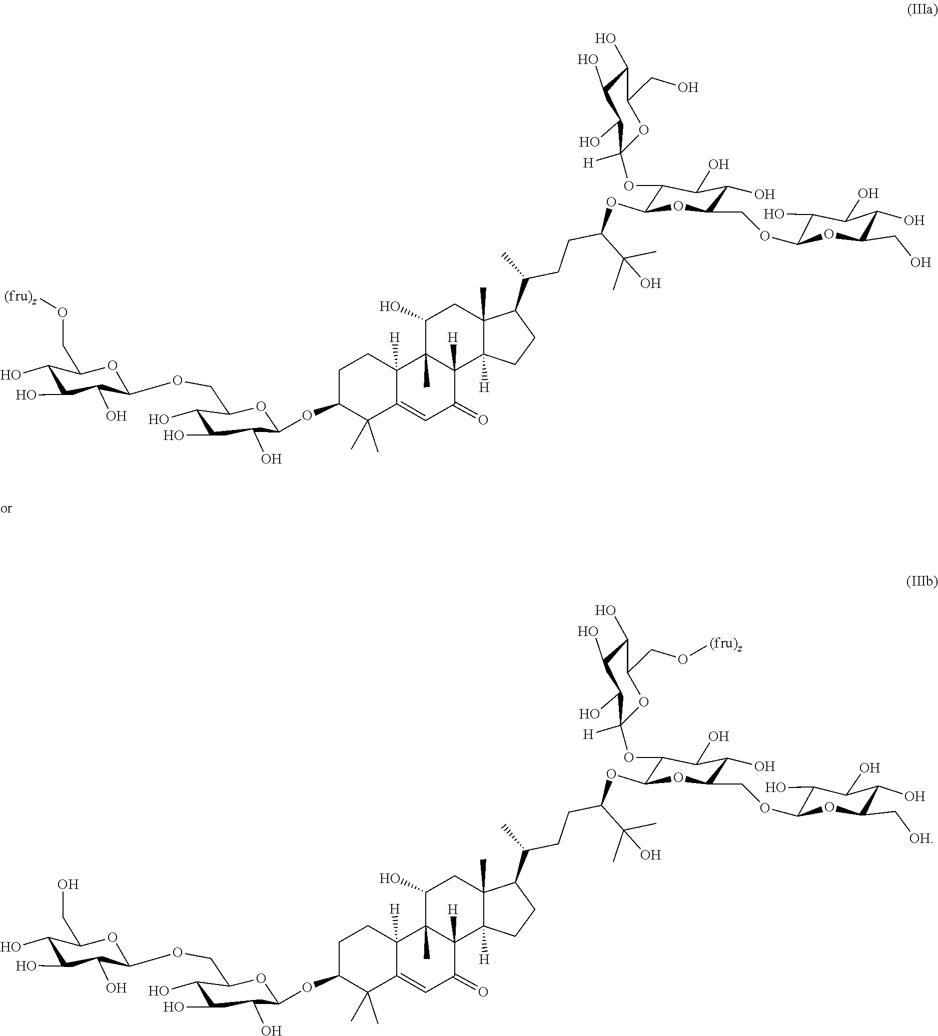

In accordance with another aspect of the present invention, there is provided the use of the compositions as herein above described as a low calorie sweet functional fibre, sweet prebiotic or as a bulk sugar replacement. The use as a bulk sugar replacement ingredient may be to replace all or a portion of a sugar or sucrose content of a foodstuff. The functional fibre compositions can be used in combination with probiotic supplements and/or other prebiotics.

It will be apparent to the skilled addressee that a number of the features of the composition listed in respect to a number of the aspects of the invention will be interchangeable with the composition administered in the present method.

### DETAILED DESCRIPTION OF THE INVENTION

Embodiments of the present invention will now be described, by way of examples only.

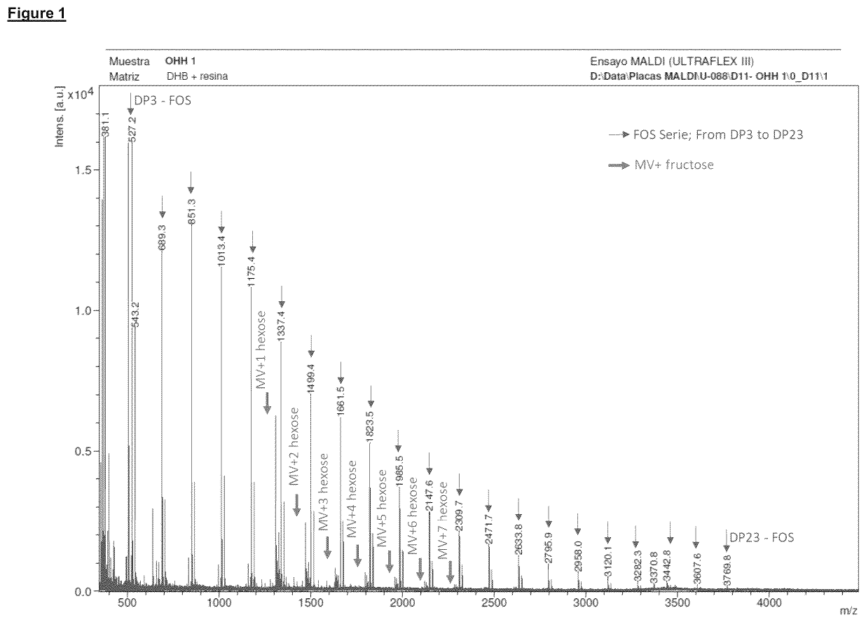

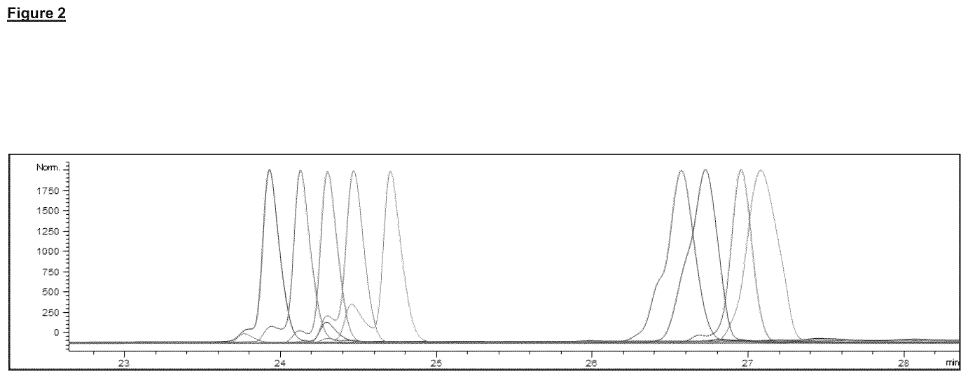

FIG. 1 shows fructosylated mogroside V detected by MALDI-ToF;

FIG. 2 shows purified fructosylated mogroside V fractions detected by LC-UV in an overlay chromatogram. Fractions were analysed by NMR and MALDI;

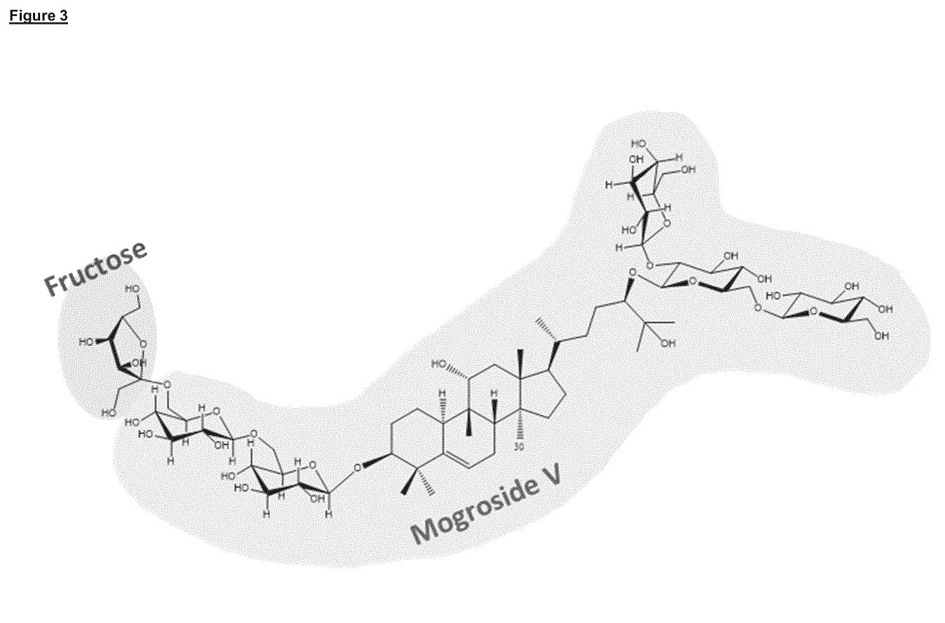

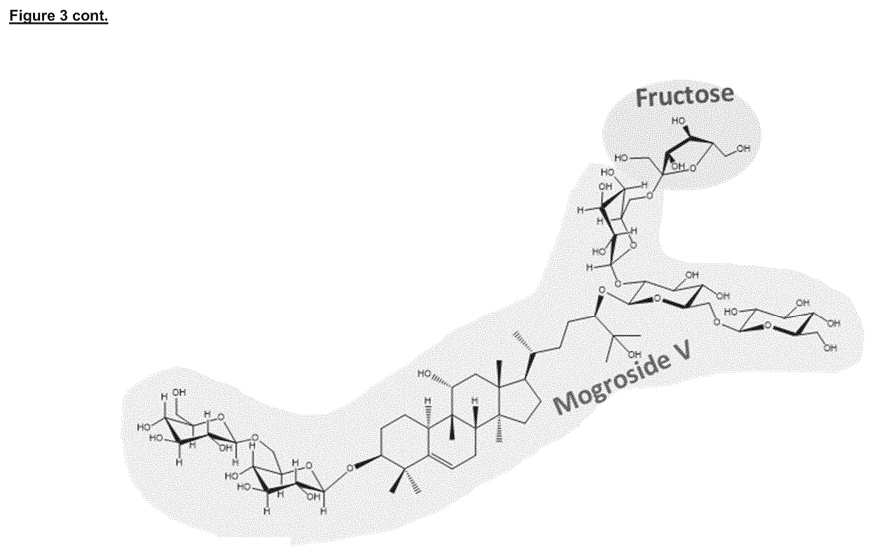

FIG. 3 shows mogroside V fructosylated structure elucidated by NMR mogroside V;

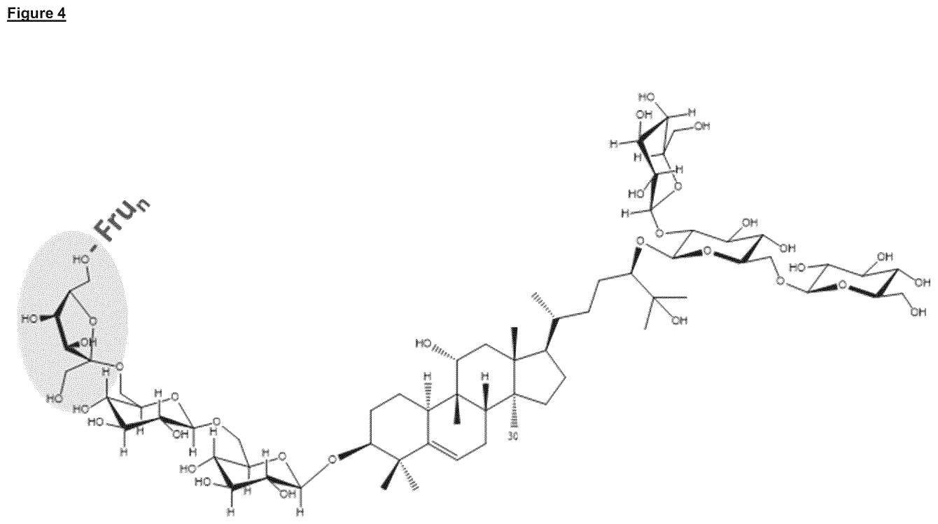

FIG. 4 shows mogroside V fructosylated structure elucidated by NMR with potential site of fructoses indicated;

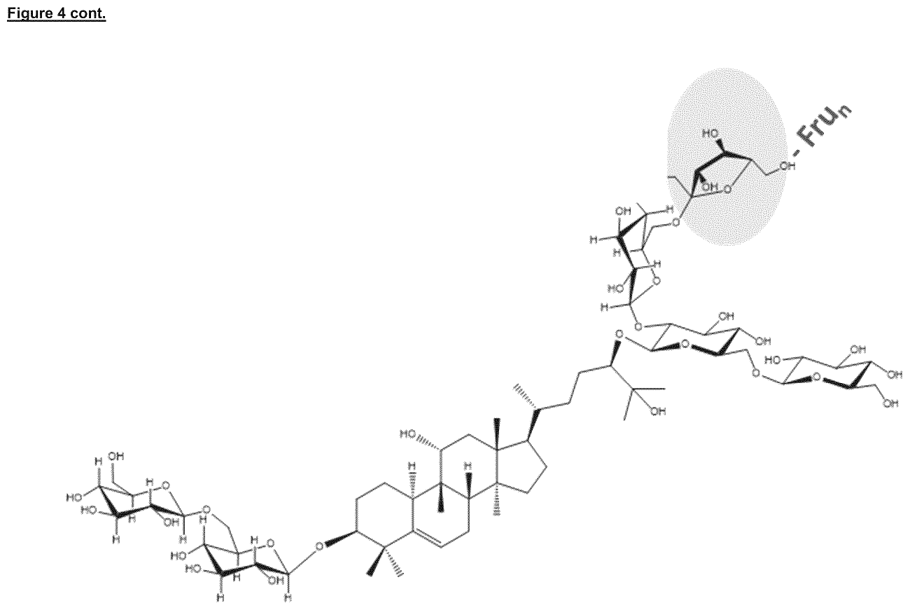

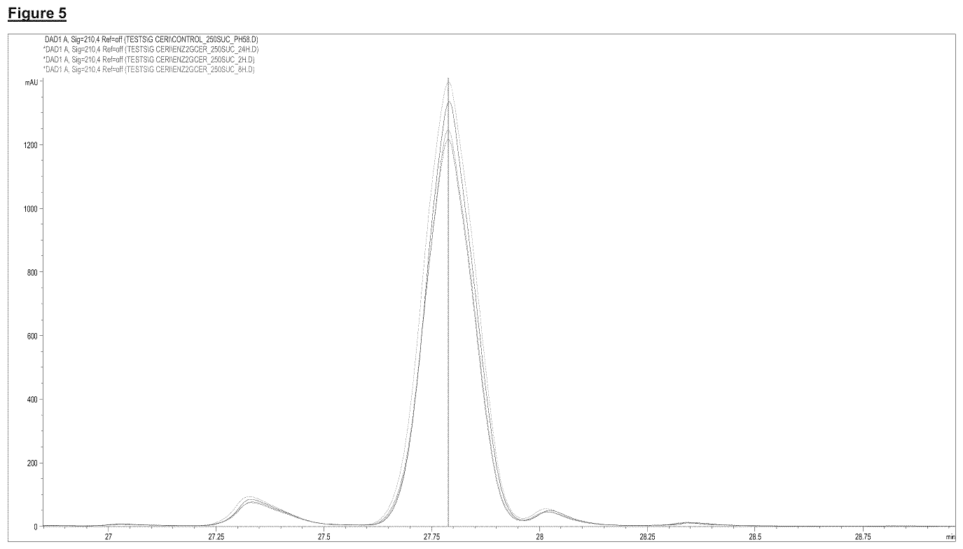

FIG. 5 Screening results using extracelular levansucrase from Gluconobacter cerinus, Mogroside V at 0.2% w/v, 250 g/L sucrose over 24 hours;

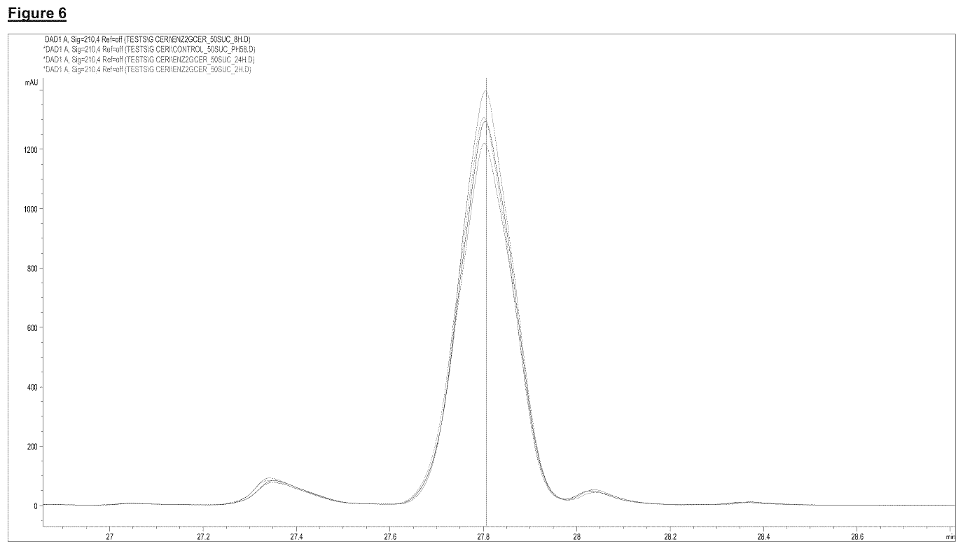

FIG. 6 Screening results using extracellular levansucrase from Gluconobacter cerinus, mogroside V 0.2% w/v, 50 g/L sucrose over 24 hours;

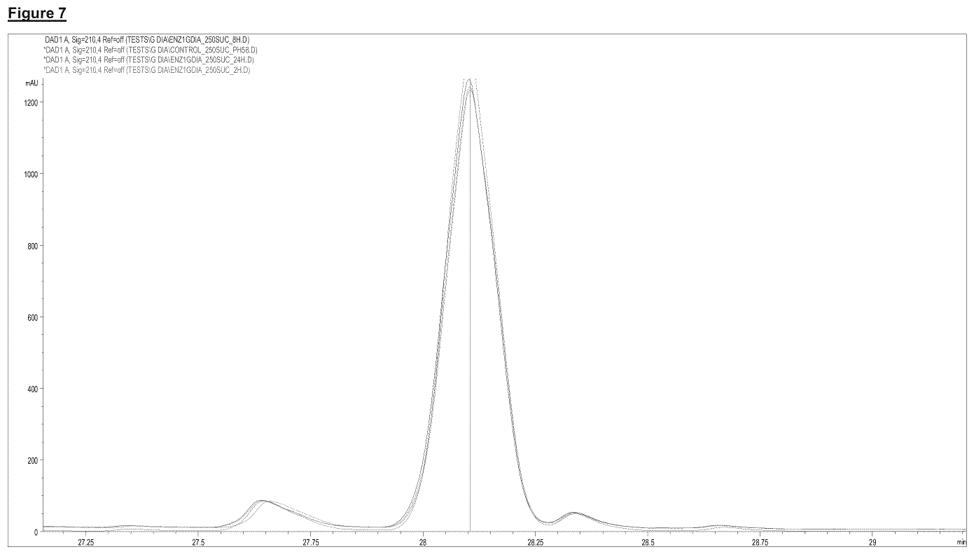

FIG. 7 Screening results using extracelular levansucrase from Gluconacetobacter diazotrophicus, mogroside V 0.2% w/v, 250 g/L sucrose over 24 hours;

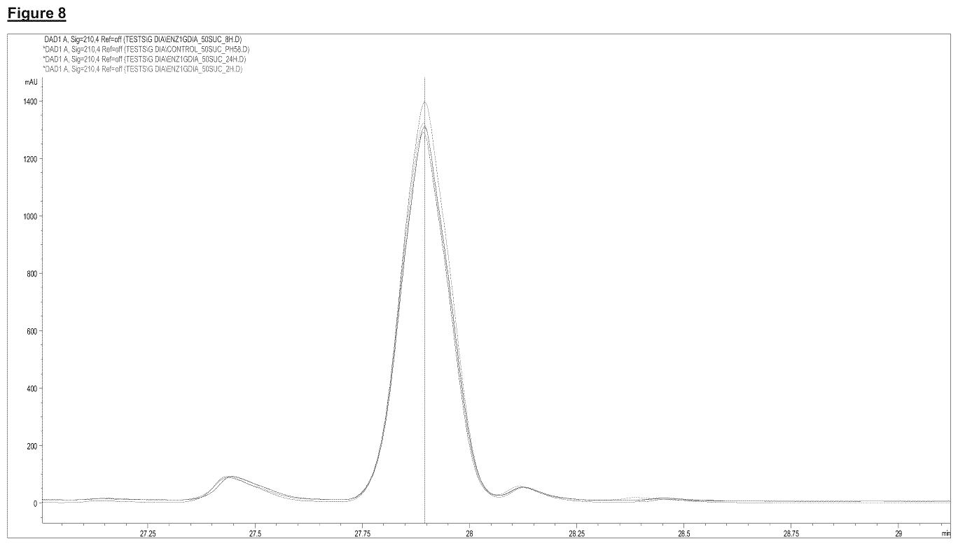

FIG. 8 Screening results using extracelular levansucrase from Gluconacetobacter diazotrophicus, mogroside V 0.2% w/v, 50 g/L sucrose over 24 hours;

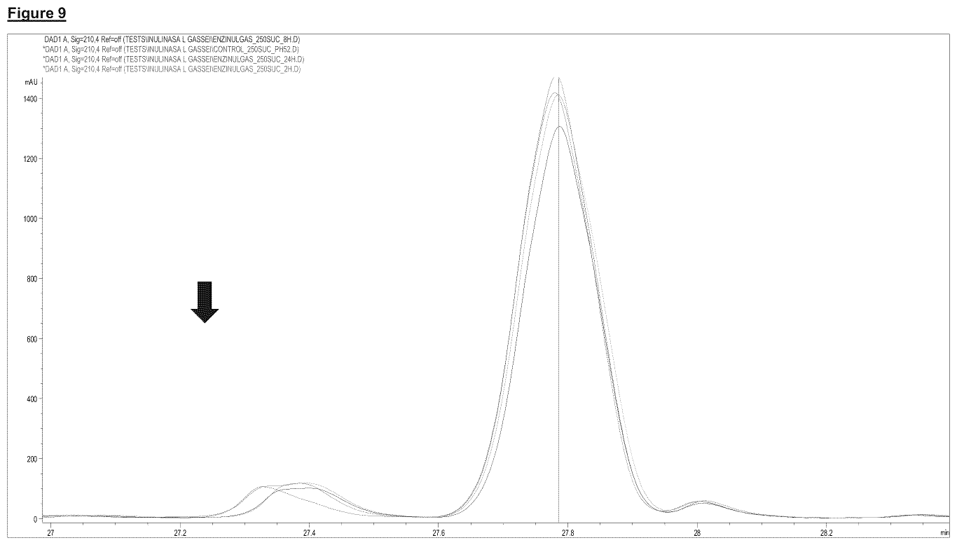

FIG. 9 Screening results using recombinant inulosucrase from Lactobacillus gasseri DSM 20604, mogroside V 0.2% w/v, 250 g/L sucrose over 24 hours;

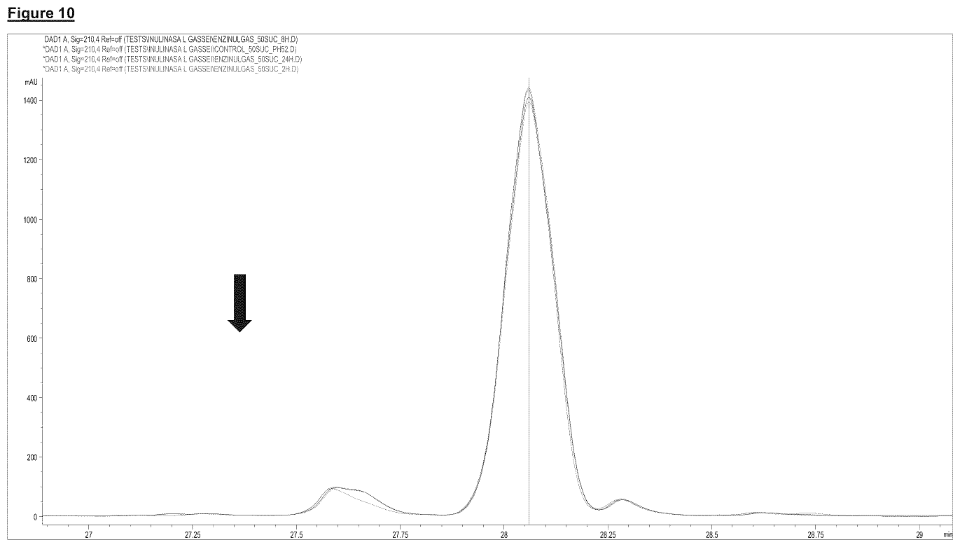

FIG. 10 Screening results using recombinant inulosucrase from Lactobacillus gasseri DSM 20604, mogroside V 0.2% w/v, 50 g/L sucrose over 24 hours; and

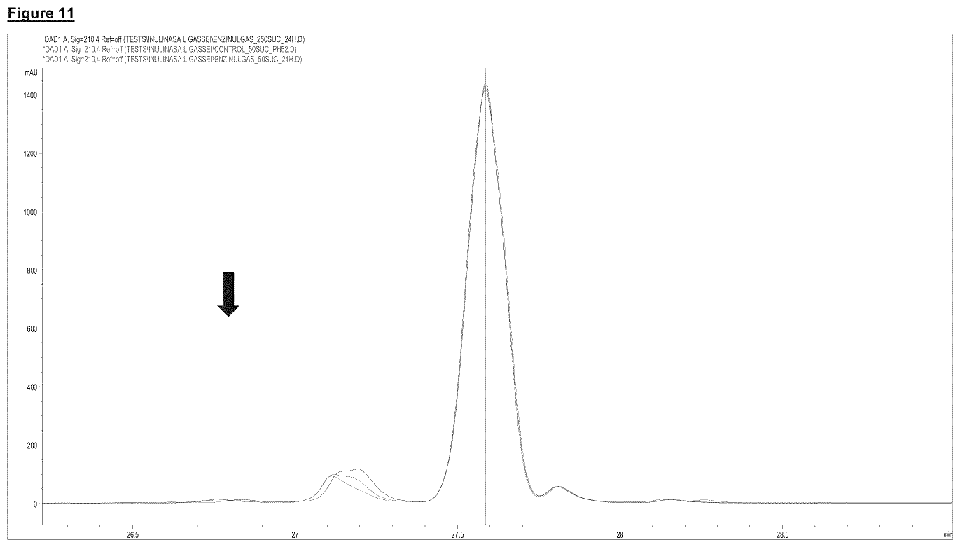

FIG. 11 Screening results using recombinant inulosucrase from Lactobacillus gasseri DSM 20604, mogroside V 0.2% w/v, using 50 g/L or 250 g/L sucrose over 24 hours.

### Fructosylation of Mogroside V by levansucrase from Bacillus species

Fructosylated mogroside V was synthesised with levansucrase from Bacillus. The transfructosylated activity of the obtained enzyme was 10 U/mg.

This enzyme has been used previously to produce different oligosaccharides, mainly lactosucrose however, no results have been described to produce fructosylated mogroside using this enzymatic system.

### Optimization of Enzymatic Activity, Time of Reaction Initial Sucrose and Mogroside V Concentration

Levansucrase from Bacillus was used to produce fructosylated mogroside. Different initial enzymatic activities of 0.05 and 0.5 U/mL were tested to determine the optimum enzymatic activity and duration of reaction for the fructosylation of mogroside. Different initial mogroside V concentrations of 0.2% to 15% were tested to determine the optimum initial mogroside V concentration for the fructosylation of mogroside. Initial sucrose concentrations ranging from 50 to 600 g/L were used to determine the optimum initial sucrose concentration for the fructosylation of mogroside. Fructosylation was carried out over up to 48 h at 37° C.

The resultant monosaccharides were quantified by GC-FID and eliminated by charcoal treatment. Other suitable purification methods include ultrafiltration, nanofiltration, yeast treatment, enzymatic treatments, membranes and chromatography. Levan production was quantified by LC-EL SD.

### Fructosylation of Mogroside V, Detected by LC-UV and MALDI-TOF

Detection of fructose units attached to mogroside V following fructosylation using levansucrase was carried out using LC-UV and MALDI-TOF. Up to 7 fructose units attached to the mogroside V have been detected. As shown no peaks were eluted after mogroside V indicating no deglycosylated mogroside V was present. No deglycosylated mogroside V was detected by MALDI-TOF either.

Fructosylation of mogroside V was detected using MALDI-TOF and is shown in FIG. 1. Fructosylation of mogroside V was also detected by LC-UV as shown in FIG. 2.

### Purifying Some Fructosylated Mogrosides to Elucidate the Structure by NMR

Some of the major fructosylated mogrosides were analysed using NMR. FIG. 3 shows the fructosylated mogroside V structure elucidated by NMR. The mogroside V was fructosylated by levansucrase (SacB). FIG. 3 shows the addition of one fructose to mogroside V.

FIG. 4 shows fructosylated mogroside V elucidated by NMR with the potential sites of further fructose attachment.

### Screening Fructosyl Transferases and Mogroside V

Extracellular levansucrase from Gluconobacter cerinus was added to 0.2% w/v mogroside V at an initial sucrose concentration of 250 g/L or 50 g/L. Levansucrase was purified according to the method of Biochem J. (1995) 309, 113-118. Samples were analysed using HPLC-UV with a C18 column at 0, 2, 8 and 24 hours.

As shown in FIGS. 5 and 6 no fructosylation was detected.

Extracellular levansucrase from Gluconacetobacter diazotrophicus was added to 0.2% w/v Mogroside V at an initial sucrose concentration of 250 g/L or 50 g/L. Levansucrase was purified according to the method of Biochem J. (1995) 309, 113-118. Samples were analysed using HPLC-UV with a C18 column at 0, 2, 8 and 24 hours.

As shown in FIGS. 7 and 8 no fructosylation was detected.

Recombinant inulosucrase from Lactobacillus gasseri DSM 20604 was added to 0.2% w/v mogroside V at an initial sucrose concentration of 250 g/L or 50 g/L. Details of inulosucrase expression and activity can be found in Appl Environ Microbiol. 2013 July;79 (13):4129-40. doi: 10.1128/AEM.00854-13. Samples were analysed using HPLC-UV with a C18 column at 0, 2,8 and 24 hours.

As shown in FIGS. 9, 10 and 11 minor fructosylation was detected, as indicated by the arrows.

The forgoing embodiments are not intended to limit the scope of the protection afforded by the claims, but rather to describe examples of how the invention may be put into practice.

1. A composition comprising:
a. a levansucrase modified high intensity sweetener glycoside;
b. a polysaccharide; and
c. unmodified high intensity sweetener glycoside.

2. The composition according to claim 1 wherein the high intensity sweetener glycoside is a mogroside or a derivative thereof.

3. The composition according to claim 2 wherein the mogroside is mogroside V.

4. The composition according to any previous claim wherein the polysaccharide is levan.

5. The composition according to any previous claim wherein the levansucrase modified high intensity sweetener glycoside is a fructosylated high intensity sweetener.

6. The composition according to claim 5 wherein the fructosylated high intensity sweetener glycoside comprises more than one additional fructose molecule.

7. The composition according to claim 6 wherein the fructosylated high intensity sweetener glycoside comprises up to 7 additional fructose molecules.

8. The composition according to any previous claim wherein the composition has a lower sweetness value than high intensity sweeteners or a composition not comprising an enzymatically modified high intensity sweetener glycoside.

9. The composition according to any previous claim wherein the composition has a reduced bitter and/or liquorice flavour when compared to a composition not comprising an enzymatically modified high intensity sweetener glycoside.

10. The composition according to any previous claim wherein the composition has an improved flavour when compared to a composition not comprising an enzymatically modified high intensity sweetener glycoside.

11. The composition according to any previous claim wherein the composition has a reduced bitter and/or liquorice flavour compared to a composition comprising an enzymatically modified high intensity sweetener glycoside produced by commercial enzymes.

12. The composition according to any previous claim wherein the composition has an improved flavour when compared to a composition comprising an enzymatically modified high intensity sweetener glycoside produced by commercial enzymes.

13. The composition according to any previous claim incorporated in, or on, a food stuff, a food supplement or a calorie restricted meal replacement product.

14. The composition according to any previous claim for use as a bulk sugar replacement or as a sweetener.

15. The composition according to any previous claim in a granular or powdered form.

16. The composition according to any previous claim as a coating of a food product.

17. A method for enzymatically modifying a high intensity sweetener glycoside comprising:
contacting the high intensity sweetener glycoside with a levansucrase in the presence of a monosaccharide acceptor to produce an enzymatically modified high intensity sweetener glycoside and a polysaccharide.

18. The method according to claim 17 wherein the high intensity sweetener glycoside is a mogroside or a derivative thereof.

19. The method according to claim 18 wherein the mogroside is mogroside V.

20. The method according to claim 19 wherein the concentration of mogroside V is 0.2-15 wt %.

21. The method according to any of claims 17 to 20 wherein the levansucrase is derived from a bacterium.

22. The method according to claim 21 wherein the levansucrase is derived from a Bacillus species.

23. The method according to any of claims 17 to 22 wherein the levansucrase activity is in the range of about 0.05 to about 0.5 U/ml.

24. The method according to any of claims 17 to 23 wherein the polysaccharide is levan.

25. The method according to any of claims 17 to 24 wherein the enzymatically modified high intensity sweetener glycoside is a fructosylated high intensity sweetener glycoside.

26. The method according to claim 25 wherein the fructosylated high intensity sweetener glycoside comprises at least one additional fructose molecule.

27. The method according to claim 26 wherein the fructosylated high intensity sweetener comprises up to 7 additional fructose molecules.

28. The method of any of claims 17 to 27 wherein the method results in no deglycosylation of the enzymatically modified high intensity sweetener.

29. The method of any of claims 17 to 28 wherein the monosaccharide acceptor is sucrose.

30. The method of claim 29 wherein sucrose is present at an initial concentration in the range of about 400 to about 600 g/L.

31. Use of the composition of any of claims 1 to 16 as a low calorie sweet prebiotic, sweet prebiotic or as a bulk sugar replacement.

32. The use according to claim 31 wherein the composition is used in combination with probiotic supplements and/or other prebiotics.

33. Use of a levansucrase for fructosylating a high intensity sweetener glycoside.

34. The use according to claim 33 wherein the levansucrase is derived from Bacillus species.

35. The use according to claim 33 or 34 wherein the high intensity sweetener glycoside is mogroside V.
d. an enzymatically modified high intensity sweetener glycoside;

36. A levansucrase enzymatically fructosylated high intensity sweetener glycoside.

37. The fructosylated high intensity sweetener glycoside according to claim 36 having the formula [(glu)ₓ-L-(glu)_{y}](fru)_{z};
wherein L is a diterpene or triterpene moiety;
wherein x and y are each independently integers from 1 to 3; and
wherein z is an integer from 1 to 8 or 1 to 7.

38. The fructosylated high intensity sweetener glycoside according to claim 37, wherein L is a cucurbitane or steviol moiety.

39. The fructosylated high intensity sweetener glycoside according to claim 4038 wherein L is a cucurbitane moiety and the compound has the formula (I): 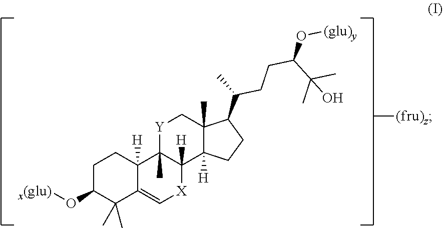
wherein X is C═O or CH₂ and Y is C═O or CHOH.

40. The fructosylated high intensity sweetener glycoside according to claim 39, selected from fructosylated mogroside IV, fructosylated mogroside V, fructosylated 7-oxo mogroside V or fructosylated siamenoside I.

41. The fructosylated high intensity sweetener glycoside according to claim 40, which is fructosylated mogroside V.

42. The fructosylated high intensity sweetener glycoside according to claim 41, having the formula (IIa) or (IIb):

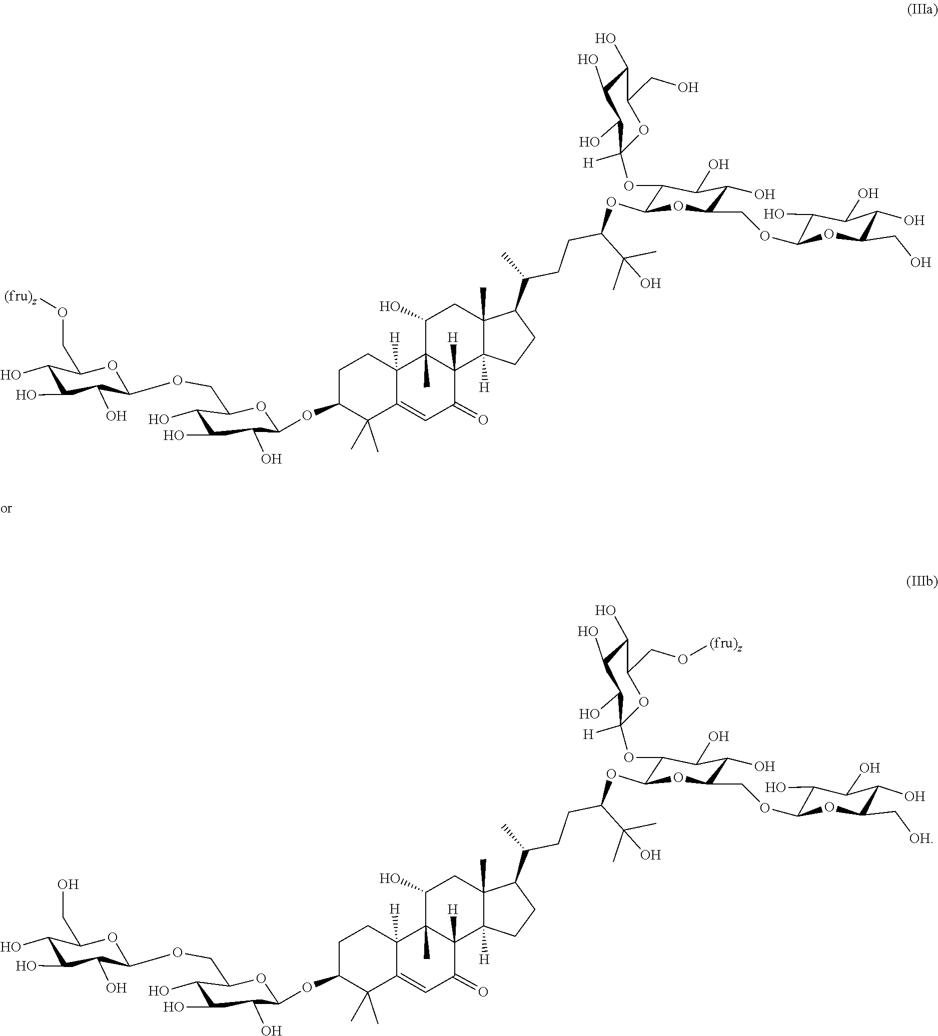

43. The fructosylated high intensity sweetener glycoside according to claim 40, which is fructosylated 7-oxo mogroside V.

44. The fructosylated high intensity sweetener glycoside according to claim 43, having the formula (IIIa) or (IIIb): [chemical structure]
